(19) United States
(12) Patent Application Publication
(10) Pub. No.: US 2018/0342153 A1
(43) Pub. Date: Nov. 29, 2018

(54) AUTONOMOUS TRAFFIC MANAGING SYSTEM

(71) Applicant: Sharp Laboratories of America, Inc., Camas, WA (US)

(72) Inventors: Stephen Ellis, Camas, WA (US); Ahmet Mufit Ferman, Vancouver, WA (US)

(21) Appl. No.: 15/605,454

(22) Filed: May 25, 2017

(51) Int. Cl. G08G 1/005; G08G 1/01; G06K 9/00; G06K 9/78

(52) U.S. Cl. CPC G08G 1/005; G08G 1/012; G08G 1/0133; G06K 9/0063; G06K 9/00771; G06K 9/78; G08G 1/0145

(57) ABSTRACT

An autonomous traffic managing system, includes at least one motorized traffic controlling mobile platform, a traffic monitoring system for receiving real-time traffic data, and a traffic managing module. In response to the real-time traffic data received and analyzed by the traffic monitoring system the traffic controlling mobile platform can autonomously manage vehicle or pedestrian traffic within the traffic control zone using the traffic managing module. The real-time traffic data is received from at least one of: one or more cameras or sensors associated with the traffic controlling mobile platform; one or more off-board sensors; a drone; and a traffic monitoring application. A plurality of traffic controlling mobile platforms can be synchronized to autonomously control traffic flow in two directions or expand or contract the size of the traffic control zone.

### FIELD OF THE DISCLOSURE

This disclosure generally relates to vehicle and pedestrian traffic management. The disclosure more specifically relates to autonomous traffic managing systems that reduce or preferably eliminate the need for human oversight.

### BACKGROUND

This disclosure describes autonomous traffic managing systems for management and control of traffic flow at, traffic control zones, such as, but not limited to, construction and work sites, where normal vehicle traffic may be disrupted due to lane closures or other temporary impediments. Currently, the majority of such construction sites utilize human workers to coordinate traffic flow. For example, two workers—commonly referred to as flaggers—are positioned at either end of the traffic control zone. The flaggers, equipped with signs to instruct vehicles, communicate with each other visibly or using radios to synchronize their actions, stopping one lane of traffic while letting the other lane of traffic to proceed.

There also exist remote control flagger assistance devices, where workers can operate traffic lights or electronic traffic signs using a wireless remote control. While these products are an improvement over human flaggers alone, they also have their deficiencies. For example:

They require a dedicated human operator to continuously monitor traffic and control the signs.

Such systems provide only a single function and provide little opportunity for value-added capability, such as data collection services.

Lack of network connectivity further limits the utility of these solutions. Without support for remote interaction and monitoring, the systems require a human operator to physically attend to issues. Furthermore, automatically tracking the locations of the flagger assistance devices is not possible.

### BRIEF DESCRIPTION OF THE DRAWINGS

FIG. 1A is a block diagram depicting the basic elements of an autonomous traffic managing system.

FIG. 1B is a block diagram depicting potential data sources used by the autonomous traffic managing system.

FIG. 2 is perspective view of an exemplary embodiment of a motorized traffic controlling mobile platform for use with an autonomous traffic managing system.

FIG. 3A is an overhead view of the autonomous traffic managing system being used to monitor and control vehicular traffic.

FIG. 3B is another overhead view of the autonomous traffic managing system being used to monitor and control vehicular traffic.

FIG. 3C is another overhead view of the autonomous traffic managing system being used to monitor and control vehicular traffic.

FIG. 3D is an overhead view of the autonomous traffic managing system being used to monitor and control pedestrian and vehicular traffic.

FIG. 3E is another overhead view of the autonomous traffic managing system being used to monitor and control pedestrian and vehicular traffic.

FIG. 3F is another overhead view of the autonomous traffic managing system being used to monitor and control pedestrian and vehicular traffic.

FIG. 4 is a graphical representation of how traffic may be managed by the autonomous traffic managing system.

### DETAILED DESCRIPTION OF THE DRAWINGS

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

This disclosure describes an autonomous traffic managing system that requires minimal or preferably no human user intervention for efficient and safe traffic management. Furthermore, the traffic managing system takes advantage of various traffic data sources to more effectively control vehicle flow and reduce traffic congestion.

Generally, “autonomous” may have one or more different definitions. For example, autonomous may mean:

a human operator controlling the traffic managing system from a nearby location using a handheld controller, similar to a remote control toy car, see e.g., U.S. Pat. No. 9,365,987;

a human operator controlling the traffic managing system from a distant location using a handheld controller and video feeds coming from the traffic controlling mobile platform and other sources of data; or

the traffic managing system is fully autonomous and controlled by software algorithms that use various traffic data sources such as local maps, general or specific traffic control rules, etc., in which, what the system does and where, at any particular moment, is determined by the traffic data received and the accessible algorithms and not by human oversight.

As used herein, unless otherwise specified, the definition of autonomous used is the third one. The described traffic managing system is fully autonomous and controlled by software algorithms that include various traffic data sources such as local maps, general or specific traffic control rules, etc., in which what the autonomous traffic managing system does and where, at any particular moment, is determined by the traffic data received and the accessible algorithms and not by human oversight.

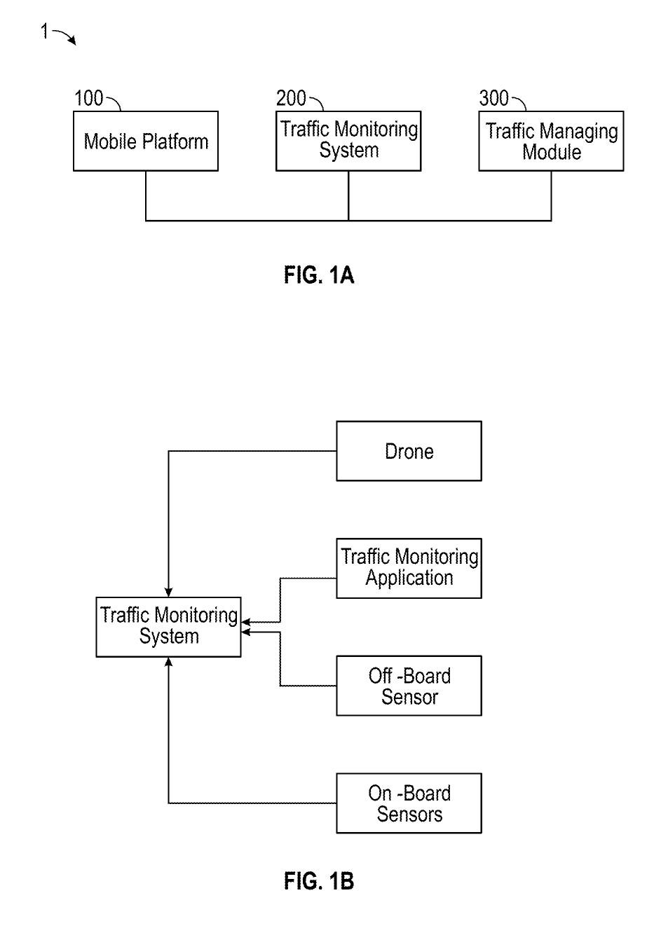

As shown in FIG. 1A, autonomous traffic managing system 1 comprises three general parts. Generally, the autonomous traffic managing system 1 includes: one or more motorized traffic controlling mobile platform(s) 100 (aka “mobile platform”); a traffic monitoring system 200; and a traffic managing module 300.

In its most basic operation, as shown in FIG. 1B and described in detail below, the traffic monitoring system 200 receives traffic data from one or more of several sources. In response to the traffic data received by the traffic monitoring system 200, the one or more mobile platform(s) 100 can autonomously and synchronously manage vehicle or pedestrian traffic within a traffic control zone using features associated with the mobile platform(s) 100 and traffic managing module 300. A non-limiting example of a traffic control zone may be a construction zone.

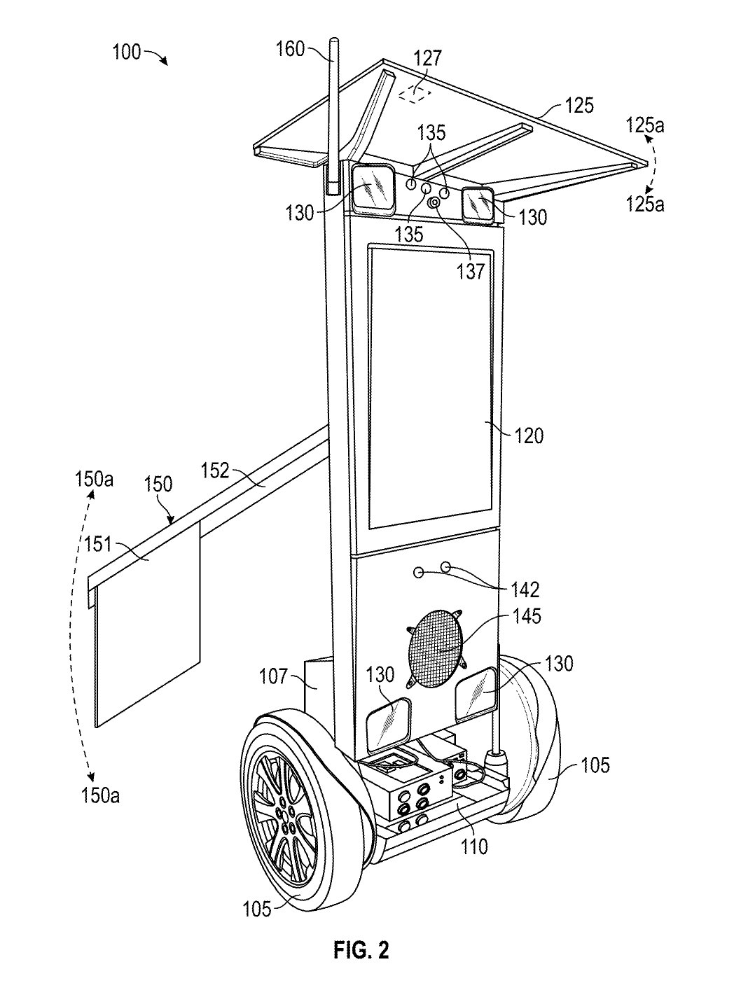

FIG. 2 shows an exemplary embodiment of a mobile platform 100. The one or more mobile platform(s) 100 may sometimes be referred to as an autonomous finger 100.

The one or more mobile platform(s) 100, each comprises a platform 110 that can be operated autonomously or using remote control to move and position the autonomous traffic managing system using a drive motor 107 and tires/wheels 105, for example, in the manner of a SEGWAY-type™ stand-up vehicle. Batteries, on-board processors, data storage components and other conventional system modules (not specifically referred to and/or not shown) are supported by the one or more platform(s) 110.

An adjustable hood 125 can be placed atop the one or more mobile platform(s) 100 to reduce glare and improve visibility of display features. Adjustable hood 125 can pivot in the directions of arrow 125a-125a.

Solar panels 127 (only one of which is shown for simplicity) may be placed on the top of the hood 125 to charge on-board batteries and eliminate the need for frequent battery changes.

The traffic managing module 300 may include a display 120 mounted on the one or more mobile platform(s) 100 and used to display traffic-related signage and messages to motorists and pedestrians. A high-contrast information display that is ruggedized to withstand the elements may be used. One or more displays 120 can be mounted on each side of the one or more mobile platform(s) 100, thereby allowing a single mobile platform 100 to manage traffic flow in both directions.

Traffic managing module 300 may also use lights 130, such as strobe lights, marker lights and/or floodlights located adjacent or around the display 120 to further increase visibility of the one or more mobile platform(s) 100 in all weather conditions, assist in nighttime deployment, and to improve autonomous navigation performance of the one or more mobile platform(s) under poor lighting conditions.

Traffic managing module 300 may also use built-in microphones 142 and speakers 145 that allow two-way audio communication, as well as playback of live or pre-recorded audio messages. For example, audio/video (a/v) capability may include the ability to audibly give commands or warnings (e.g. pre-recorded) to drivers or pedestrians. Or, the a/v capability may include the ability to visibly give commands, warnings, or other information to drivers or pedestrians, using, e.g., display 120.

For traffic monitoring system 200, mobile platform 100 may access a variety of different traffic data sources.

For example, the autonomous traffic managing system 1 may be equipped with on-board sensors 135.

On-board sensors 135, such as an ultrasonic sensor for obstacle detection may be used for traffic monitoring, while other sensor types 135 may be used for autonomous control and navigation of the one or more mobile platform(s) 100 itself when mobile platform(s) 100 move around a traffic control zone.

Traffic monitoring system 200 may also access cameras 137 on either or both sides of the one or more mobile platform(s) 100 that stream and record live video data and include the ability to take video or still photos of local traffic conditions, count passing vehicles, etc., and forward that data to the traffic managing module 300 or a remote location for human or computer analysis apart from local traffic management.

The camera 137 may comprise HD (high definition), stereo, and/or an RGB-D camera for vision-based navigation; LIDAR(s) for mapping, navigation, and obstacle detection; and a GPS receiver for navigation.

Camera 137 may be associated with image analysis software that is part of either or both of traffic monitoring system 200 and traffic controlling module 300. The image analysis software can identify and ticket traffic violators (speeders; vehicles that disobey displayed signs) or detect humans and other objects in the traffic control zones.

Traffic managing module 300 may include a movable blocking member 150 for warning a vehicle or pedestrian to not proceed when the member is in a first, lowered, position and signaling the vehicle of pedestrian to proceed when the member is in a second, raised, position (see arrow 150a-150a).

Blocking member 150 can comprise a retractable or rotatable arm 152 on one or both sides of the one or more mobile platform(s) that can be used as a barrier or a physical flag 151 to signal motorists; the movements of the arm(s) can be synchronized with the displayed message (e.g., the arm(s) can be lowered automatically when “Stop” is displayed on display 120).

The autonomous traffic managing system 1 can be programed through off-the-shelf command and control (C&C SW) and associated user interface. The C&C SW can be deployed on a desktop or laptop computer system, or a mobile processing platform such as a tablet or mobile phone. The C&C SW features a map interface that allows an operator to define an operating traffic control zones for mobile platform units 100; define traversable paths and routes; and define and schedule position changes, and take into account other traffic or route data. Furthermore, using the C&C SW, an operator can schedule tasks and define messages to be automatically displayed on the one or more mobile platform(s) display 120. The C&C SW may be kept on board mobile plaform(s) 100 or shared between mobile platform(s) 100, the cloud, and/or a remote server.

Communication between the autonomous traffic managing system 1, data sources, and control software may be established using a wireless or cellular network, or a peer-to-peer connection between the traffic data sources and the one or more mobile platform(s) 100 using antenna 160. While an off-site operator can interact with, and manage, multiple mobile platform 100 units remotely, thereby eliminating the need to be in physical proximity to the units, as mentioned before, after programming using the C&C SW, autonomous traffic managing system 1 can cause its one or more mobile platform(s) 100 to move around and operate without human oversight (unless an emergency situation arises, in which a human may be notified). Data from the built-in sensors 135 and cameras 137 in the one or more mobile platform(s)s 100 are streamed to the C&C SW, thereby allowing the operator to observe the surrounding environment of any particular mobile platform 100.

Mobile platform 100 operates through the use of real-time traffic data to manage traffic in a traffic control zone.

The real-time traffic data is received from at least one of: one or more cameras 137 or sensors 135 associated with the one or more mobile platform(s) 100 (described above); one or more off-board sensors (described below); a traffic monitoring drone (described below); or a traffic monitoring application (described below).

The autonomous traffic managing system 1 can receive real-time data from off-board sensors, for example, local traffic control equipment, such as red light sensors and traffic cameras. This allows the autonomous traffic managing system 1 to gather traffic information from sensor equipment near the traffic control zone and adjust traffic patterns accordingly (see below).

The autonomous traffic managing system 1 can also receive real-time data from traffic monitoring applications such as Waze to intelligently plan traffic flow in advance. This connection can be established using the built-in wireless or cellular connectivity on the one or more mobile platform(s) 100. For example, traffic patterns within a several mile radius on the construction zone may be received from the traffic monitoring applications and monitored by the autonomous traffic managing system 1, and vehicle or pedestrian wait times or detours may be adjusted based on the traffic data.

Finally, real-time traffic data may also be communicated directly from one or more scout vehicles, such as aerial or ground-based drones, that monitor the conditions in the traffic control zone and report traffic data to the autonomous traffic managing system 1.

Traffic data may also be determined automatically by comparing baseline data collected by the scout vehicles for the same route under normal circumstances to traffic data accumulated during construction.

Additionally, the one or more mobile platform(s) 100 may be used as a “lead” vehicle to guide other vehicles through traffic, based on the received traffic information or a defined detour that is communicated to the one or more mobile platform(s) 100.

Traffic management can be performed in a number of ways and operating modes. In one operating mode, the one or more mobile platform(s) 100 dynamically analyze the video captured by their cameras and determine when to adjust traffic flow, the size of the traffic control zones, etc., based on the number of vehicles waiting in each direction.

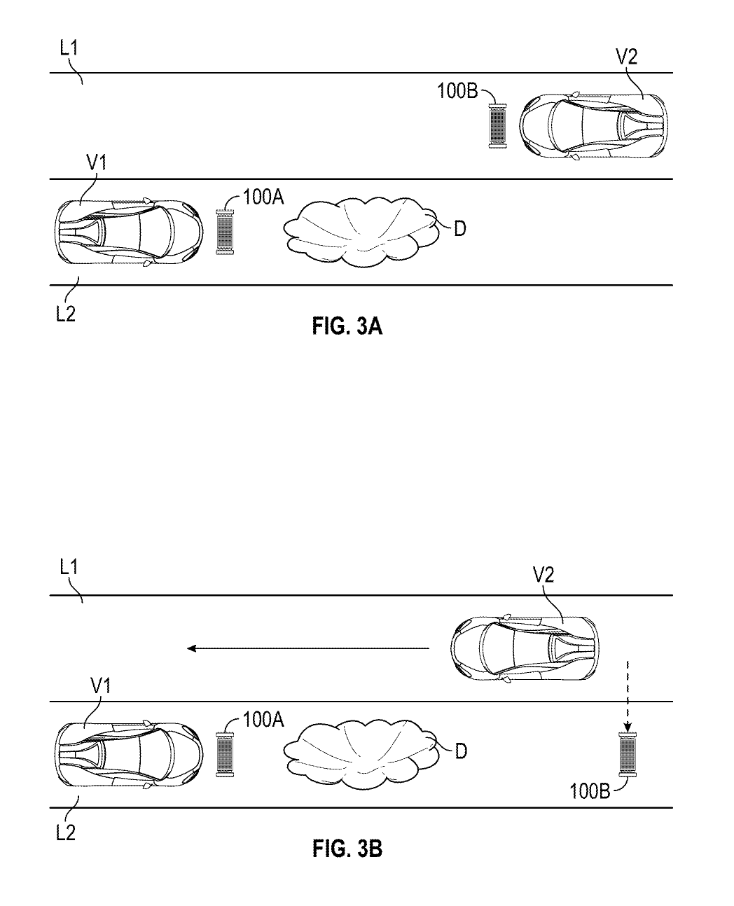

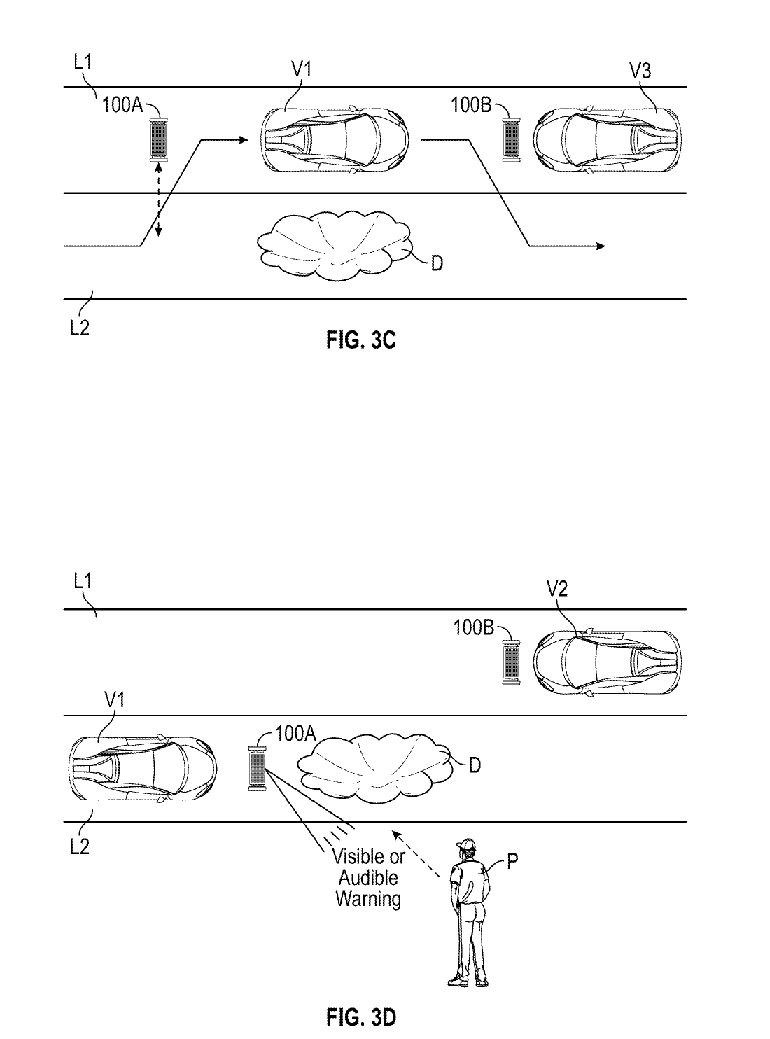

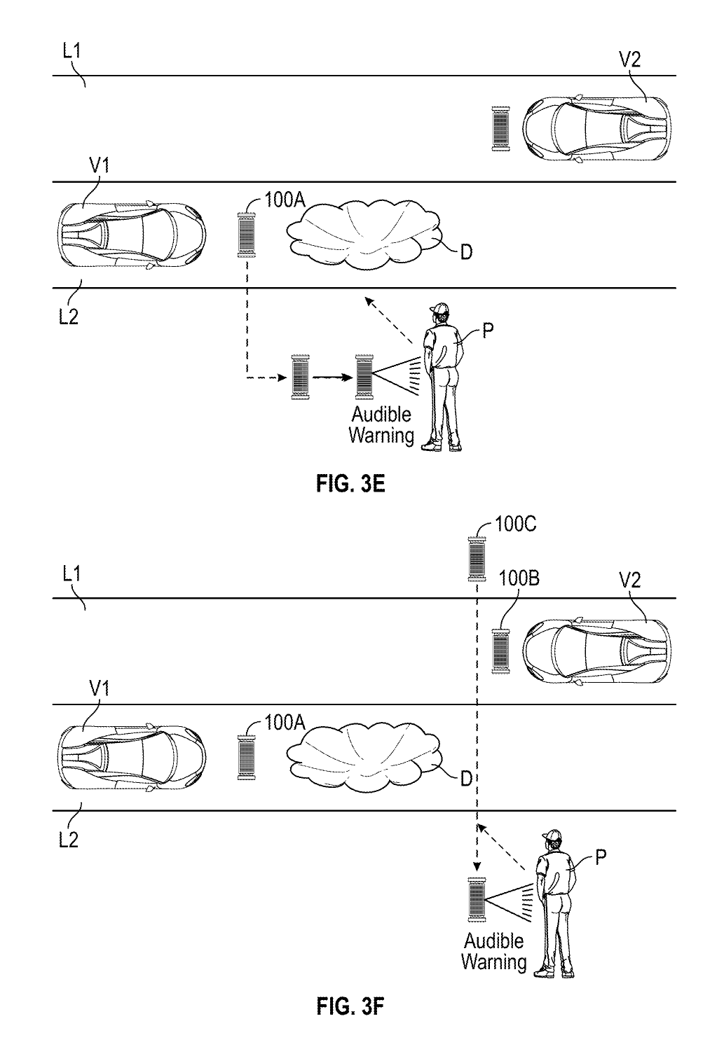

FIG. 3A, FIG. 3B, FIG. 3C, FIG. 3D, FIG. 3E, show a variety of non-limiting potential uses for the system wherein the traffic control zone comprises a construction zone.

In FIG. 3A, two mobile platforms 100A, 100B are blocking traffic in both directions (lanes L1, L2) at a construction site where a large ditch, hole, or other road obstruction D is located and blocking one of lanes L1, L2.

Typically, according to the prior art, human flaggers, in communication with each other using two-way radios would alternately control the traffic flow in each direction. Traffic flow from the two lanes are alternatingly allowed to move over the lane not under construction or obstructed.

In this embodiment, the traffic monitoring system 200 monitors the entrance and exit of vehicles and/or pedestrians within the traffic control zone. This can be achieved, using, for example, the cameras 137 and sensors 135 or any other traffic data source, including those mentioned above.

In FIG. 3B, traffic in one of lanes L1, L2 may be allowed to pass through the construction zone. For example, mobile platform 100B autonomously moves itself clear of blocking lane L1, thereby allowing vehicle V2 to continue through the construction zone. Screen 120 can instruct vehicles to keep right, caution, or provide any other information or warning. Similarly, speaker 130 can announce similar warnings audibly.

In FIG. 3C, after one or more vehicles V2 pass through, after either: a fixed time period, a fixed number of cars pass through the construction zone, or no other vehicles are located in lane L1, mobile platform 100B autonomously returns itself to its position blocking traffic in lane L1, whereby the next vehicle V3 will be prevented from continuing through the construction zone.

Also in FIG. 3C, Mobile platform 100A will autonomously move itself out of the path of vehicle V1, thereby allowing vehicle V1 to continue through the construction zone. Screen 120 can instruct vehicles to keep left, caution, or provide any other warning or information. Similarly, speaker 130 can announce similar information or warnings audibly.

Again, after one or more vehicles V1 pass through, after: either a fixed time period, a fixed number of cars pass through the construction zone, or no other vehicles are located in lane L2, mobile platform autonomously 100A returns itself to its position blocking traffic in lane L2, whereby any other vehicles (not shown) will be prevented from continuing through the construction zone.

Alternatively, to mobile platforms 10A, 100B autonomously moving themselves in and out of positions blocking their respective lanes L1, L2, the one or more mobile platform(s)s 100 can be off to the side (e.g., in the road shoulder area) and their respective blocking members autonomously raised and lowered to control traffic flow through the construction zone.

In FIG. 3D, a pedestrian P approaches the construction zone. Pedestrian P may or may not be able see obstruction D. Autonomous traffic managing system 1 will detect the pedestrian entering the traffic control zone and determine whether the risks to the pedestrian are greater than the risks to the vehicles. If the risk to the pedestrian is less than the risk to the vehicles, the traffic controlling mobile platforms 100 will stay in their waiting positions but issues a visual or audible warning to the pedestrian.

In FIG. 3E, again, a pedestrian P approaches the construction zone. Pedestrian P may or may not be able see obstruction D. Autonomous traffic managing system 1 will detect the pedestrian entering the traffic control zone and determine whether the risks to the pedestrian are greater than the risks to the vehicles. If the risk to the pedestrian is greater than the risk to the vehicles, one of mobile platform(s)s 100A, 100B, e.g., the mobile platform closest to the pedestrian, e.g., mobile platform 100A, autonomously moves to a location where it can more forcibly audibly and visibly warn or block the pedestrian from further movement into the construction zone. Before moving towards the pedestrian, the one or more mobile platform(s) 100 can audibly or visibly warn the waiting vehicles to remain at their positions.

In FIG. 3F, in situations where pedestrian traffic is highly expected, a third mobile platform 100C may be provided and which generally waits in a standby area in or toward the road shoulder. A pedestrian P approaches the construction zone. Pedestrian P may or may not be able see obstruction D. The autonomous traffic managing system 1 can cause mobile platform 100C to autonomously move from its standby position to a location where it can audibly or visibly warn or even block the pedestrian from further movement into the construction zone while mobile platforms 100A, 100B, can autonomously continue to manage vehicle traffic.

Thus, in FIG. 3F, the system comprises separate mobile platforms 100 for managing vehicle and pedestrian traffic.

Depending on the real-time traffic data received by the traffic monitoring system 200, the traffic control zone in which the system is real-time managing vehicle or pedestrian traffic can be expanded or contracted. That is, if the traffic data received by the traffic monitoring system 200 indicates heavy traffic at a particular location, additional traffic controlling mobile platforms 100 can be autonomously moved to positions where they can create and/or signal detours, or autonomously create the detours by autonomously accessing infrastructure traffic control equipment (traffic lights, traffic cameras, electronic signage), by networks or other means.

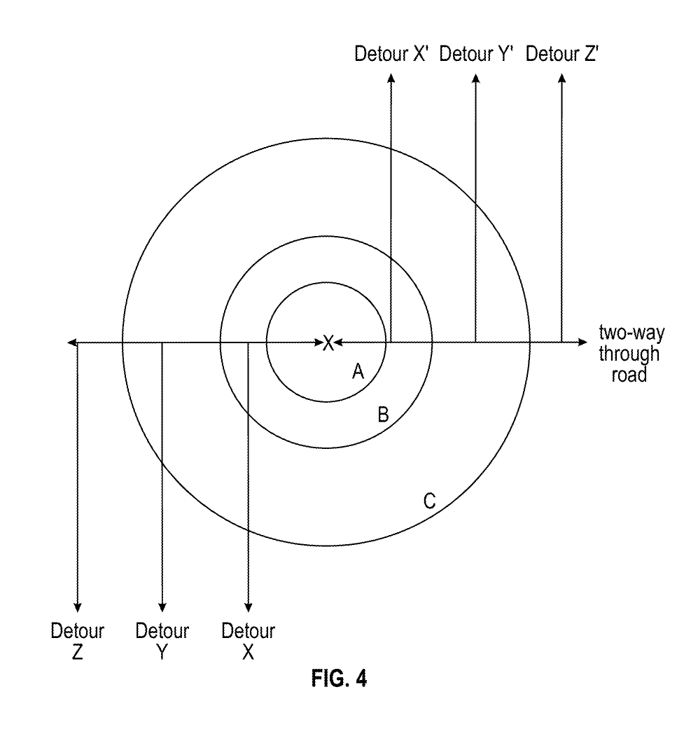

FIG. 4 depicts how, depending on the traffic data received by the traffic monitoring system 200, the traffic control zone in which the autonomous traffic managing system 1 is managing vehicle or pedestrian traffic can be expanded or contracted.

For example, traffic control zone X is the construction zone and construction zone X is in larger traffic control zone A. Traffic control zone X is the general location of the one or more mobile platform(s)s as previously described with reference to FIGS. 3A-3F.

If traffic in traffic control zone A becomes too large, mobile platforms 100 may autonomously move to locations that allow the mobile platforms to create detours X, X′, which prevent additional vehicles from entering traffic control zone A and the construction zone X.

If traffic in traffic control zone B becomes too large, mobile platforms may autonomously move to locations that allow the mobile platforms to create detours Y, Y′, which prevent additional vehicles from entering traffic control zones B, A and the construction zone X.

If traffic in traffic control zone C becomes too large, mobile platforms may move to locations that allow the mobile platforms to create detours Z, Z′, which prevent additional vehicles from entering traffic control zones C, B, and A.

As traffic begins to clear as indicated by the traffic data provided to the autonomous traffic managing system 1, by autonomous movement of the various mobile platforms 100, traffic can be incrementally or all at once, let back into traffic control zones C, B, and A. Any number of traffic control zones may be defined based on existing roads.

In summary, the autonomous traffic managing system 1 according to the disclosure:

reduces risk and liability by taking human mobile platforms out of active traffic control zones.

eliminates human error and potential accidents due to human distractions, fatigue, and environmental conditions.

provides broader capability for messaging than a standard analog sign. Displayed messages can be changed manually by a human operator, or, more preferably, programmatically based on time of day; location; traffic conditions; weather; etc.

Multiple mobile platform units can communicate with each other using a wireless network and coordinate their actions to ensure safety and efficiency.

Another use case for the one or more mobile platform(s) system is after-hours traffic management, where it can warn drivers about potential road hazards (e.g., ongoing traffic revisions, bumps, etc.). High-contrast, high visibility, display and built-in marker lights ensure that drivers are alerted well in advance. Additional functionality, such as vehicle speed detection, can be incorporated in the one or more mobile platform(s) to notify drivers about potential safety issues.

The embodiments shown and described above are only examples. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

That which is claimed:

1. An autonomous traffic managing system, comprising:
at least one motorized traffic controlling mobile platform;
a traffic monitoring system for receiving traffic data;
a traffic managing module;
wherein in response to the traffic data received and analyzed by the traffic monitoring system the at least one traffic controlling mobile platform can autonomously manage vehicle or pedestrian traffic within a traffic control zone using the traffic managing module.

2. The autonomous traffic managing system of claim 1, wherein the traffic monitoring system monitors the entrance and exit of vehicles and/or pedestrians within the traffic control zone.

3. The autonomous traffic managing system of claim 2, wherein the traffic control zone comprises a construction zone.

4. The autonomous traffic managing system of claim 1, wherein if the autonomous traffic managing system detects a pedestrian and determines the risk to the pedestrian exceeds the risk to a vehicle, at least one traffic controlling mobile platform autonomously moves to a location where it can warn or block the pedestrian from further movement into the area.

5. The autonomous traffic managing system of claim 1, wherein if the autonomous traffic managing system detects a pedestrian and determines the risk to the pedestrian does not exceed the risk to a vehicle the traffic controlling mobile platform stays where it is but autonomously issues an audible and/or visible warning to the pedestrian.

6. The autonomous traffic managing system of claim 1, wherein the autonomous traffic managing system comprises at least two traffic controlling mobile platforms and one traffic controlling mobile platform manages vehicle traffic and a second mobile platform manages pedestrian traffic.

7. The autonomous traffic managing system of claim 1, wherein the autonomous traffic managing system comprises at least two traffic controlling mobile platforms and synchronously each of the two traffic controlling mobile platforms controls the traffic flow in one direction of travel.

8. The autonomous traffic managing system of claim 1, wherein the traffic controlling mobile platform includes a movable blocking member for warning a vehicle or pedestrian to not proceed when the member is in a first position and allowing the vehicle or pedestrian to proceed when the member is in a second position.

9. The autonomous traffic managing system of claim 1, wherein the traffic monitoring system receives real-time traffic data to manage the traffic.

10. The autonomous traffic managing system of claim 1, wherein the autonomous traffic managing system controls traffic flow in the traffic control zone by autonomously moving the traffic controlling mobile platforms from positions blocking traffic to a position not blocking the traffic.

11. The autonomous traffic managing system of claim 9, wherein the real-time traffic data is received from at least one of:
one or more cameras or sensors associated with the traffic controlling mobile platform;
one or more off-board sensors;
a drone; and
a traffic monitoring application.

12. The autonomous traffic managing system of claim 1, wherein the at least one traffic controlling mobile platform is at least partially solar powered.

13. The autonomous traffic managing system of claim 1, wherein the traffic controlling mobile platform has audio/video (a/v) capability.

14. The autonomous traffic managing system of claim 13, wherein the a/v capability includes the ability to autonomously give audible or visible commands, warnings, or information to drivers or pedestrians.

15. The autonomous traffic managing system of claim 13, wherein the a/v capability includes the ability to take video or still photos of local traffic conditions and forward that data to the traffic managing module or a remote location for human or computer analysis.

16. The autonomous traffic managing system of claim 1, wherein depending on traffic data received by the traffic monitoring system, the traffic control zone in which he autonomous traffic managing system is managing vehicle or pedestrian traffic can be automatically expanded or contracted.

17. An autonomous traffic managing system, comprising:
a motorized traffic controlling mobile platform, the platform accessing;
a real-time traffic monitoring system for receiving traffic data;
a real-time traffic managing module;
wherein in response to the traffic data received and analyzed by the real-time traffic managing system, the traffic controlling mobile platform can autonomously manage vehicle or pedestrian traffic using the traffic managing module.

18. The autonomous traffic managing system of claim 17, wherein the real-time traffic data is received from at least one of:
one or more cameras or sensors associated with the traffic controlling mobile platform;
one or more off-board sensors;
a drone; and
a traffic monitoring application.

19. The autonomous traffic managing system of claim 17, wherein depending on the real-time traffic data received by the traffic monitoring system, the traffic control zone in which The autonomous traffic managing system is real-time managing vehicle or pedestrian traffic can be expanded or contracted.

20. The autonomous traffic managing system of claim 17, wherein if the traffic data received by the traffic monitoring system indicates heavy traffic at a particular location, additional traffic controlling mobile platforms can autonomously create and/or signal detours.
